(19) United States
(12) Patent Application Publication
(10) Pub. No.: US 2007/0045215 A1
(43) Pub. Date: Mar. 1, 2007

(54) Beverage container vent mechanism including perforated elastic membrane and support plate

(75) Inventors: James W. Holley JR., Colorado Springs, CO (US); Patrick T. Bever, Santa Clara, CA (US)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Insta-mix, Inc. Subsidiary A (DBA Umix, Inc.), Colorado Springs, CO (US)

(21) Appl. No.: 11/212,154

(22) Filed: Aug. 26, 2005

(51) Int. Cl. A61J 11/00; A61J 9/00

(52) U.S. Cl. 215/11.4; 215/11.1

(57) ABSTRACT

A venting mechanism includes a rigid support member and a thin, elastic membrane that is perforated with multiple pinholes. The support member includes a peripheral flange that is secured to the beverage container body, and a rigid support plate that defines one or more always-open vent holes. A flow control member includes the membrane and a peripheral collar surrounding the membrane that is secured to the container body by the peripheral flange. The membrane includes a thin sheet of a suitable elastomeric material that rests against an inside surface of the support plate when the pressure inside the container is equal to or greater than the surrounding environment. The pinholes are formed in the elastomeric material such that they are closed when the membrane is in the resting state, and open when the membrane is stretched in response to a pressure differential or an applied force.

### FIELD OF THE INVENTION

The present invention relates to beverage containers, and more specifically it relates to vent mechanisms for regulating internal pressure of bottle-type beverage containers.

### RELATED ART

Bottle-type beverage containers, such as baby bottles, utilize various conventional venting mechanisms that prevent vacuum generation by admitting air into the container to replace the volume of liquid drawn out by a feeding baby through a nipple, thereby allowing a baby to feed without stopping to allow air into the bottle through the nipple.

One such conventional venting mechanisms utilized in baby bottle assemblies includes a slit-like vent hole formed in the flange surrounding a baby bottle nipple, which is secured to a threaded neck of the baby bottle by way of an annular cap. This vent hole is biased into a closed position when the bottle is not in use, and opens to allow the inflow of air in response to lower pressure generated by the feeding baby. A problem with this type of conventional venting mechanism is that the air entering the baby bottle passes through the remaining milk or formula, causing the generation of bubbles that may be subsequently consumed by the baby.

A second type of conventional venting mechanism utilized in baby bottle assemblies is mounted onto a bottom of the bottle and includes a domed diaphragm having several slit-like openings that are biased into a closed position to prevent leakage when the bottle is not in use, and open during use to equalize internal and external pressure. In particular, when the bottle is inverted and internal pressure is generated, air enters through the slit-like openings above the surface of the stored fluid, thereby avoiding the generation of bubbles in the fluid. A problem with such domed diaphragms is that they typically require relatively complicated and expensive manufacturing equipment. In addition, the slit-like vent openings are known to weaken with repeated use and/or to trap solid material that eventually produces tearing along the edges of the slits, which can ultimately cause undesirable leakage.

What is needed is a reliable vent mechanism for a beverage container that is relatively easy to manufacture and avoids the problems associated with conventional venting structures.

### SUMMARY

The present invention is directed to a beverage container including a vent mechanism formed by a rigid support plate having one or more open vent holes (openings), and a flow control member having a membrane that is supported between the support plate and a storage chamber of the beverage container. The membrane is a thin, flat elastic sheet that is perforated to include one or more normally-closed pinholes. Because the pinholes are formed on a flat surface, manufacturing of beverage containers in accordance with the present invention is greatly simplified over conventional venting mechanisms that utilize domed diaphragms. In addition, because the pinholes are formed using pins that do not produce slits in the membrane material that can become weakened and/or trap deposits that can prevent slit flap closure, the vent mechanism of the present invention facilitates leak-free operation that is substantially more reliable than that of slit-based conventional venting mechanisms.

In accordance with an embodiment of the present invention, a beverage container includes a container body defining upper and lower openings, an nipple or nozzle assembly mounted over the upper opening, and the vent mechanism of the present invention mounted over the lower opening. The venting mechanism includes a support member and a flow control member. The support member includes a peripheral flange that is secured to the container body, and a rigid support plate that defines one or more always-open vent holes. The vent member includes a perforated membrane surrounded by a relatively durable collar that is attached to a peripheral edge of the membrane. The collar is secured to the container body by the peripheral flange of the support member, and the membrane includes a thin sheet of a suitable elastomeric material (e.g., soft rubber, thermoplastic elastomer, or silicone) that rests against an inside surface of the support plate when the pressure inside the container is equal to or greater than the surrounding environment. The pinholes are formed in the elastomeric material such that they are biased into a closed position when the membrane is in the resting state (i.e., when internal and external pressures are equalized, or when the membrane is pressed against the support plate by the weight of the stored liquid). When the membrane is stretched from its resting state away from the support plate (e.g., in response to a pressure differential or an applied force), the pinholes open to allow fluid flow into the container. The pinholes are formed by applying radial tension and puncturing the membrane using one or more pins having a substantially circular cross-section, and sized such that each pinhole is closed by the surrounding elastomeric material when the radial tension is removed.

In accordance with an embodiment of the present invention, a method for introducing beverages into a beverage storage container through the venting mechanism includes holding the membrane away from the support plate such that the pinholes are biased into an opened position, and then pumping or otherwise feeding the beverage into the bottle through the opened pinholes.

The present invention will be more fully understood in view of the following description and drawings.

### BRIEF DESCRIPTION OF THE DRAWINGS

FIG. 1 is a partial cut-away exploded side view showing a baby bottle assembly according to an embodiment of the present invention;

FIGS. 2(A) and 2(B) are top plan and partial cross-sectional side views, respectively, showing a flow control member of the baby bottle assembly of FIG. 1;

FIGS. 3(A) and 3(B) are top plan and cross-sectional side views showing a support member of the baby bottle assembly of FIG. 1;

FIG. 4 is a partial cross-sectional view showing a lower portion of the baby bottle of FIG. 1 with the flow control member in a resting state;

FIGS. 5(A) and 5(B) are enlarged cross-sectional side views showing a portion of the support member and flow control member of the baby bottle of FIG. 1; and

FIG. 6 is a simplified cross-sectional side view showing a method for inserting liquid into the baby bottle of FIG. 1 through the flow control member according to another embodiment of the present invention; and

FIG. 7 is an enlarged cross-sectional side view showing a portion of the support member and flow control member of the baby bottle of FIG. 6.

### DETAILED DESCRIPTION

The present invention is described below with specific reference to a baby bottle assembly, which represents one type of beverage container that benefits from the present invention. The appended claims are not restricted to the disclosed specific embodiment, and are intended to read on other beverage containers that may be modified to include the present invention, such as adult sport bottles.

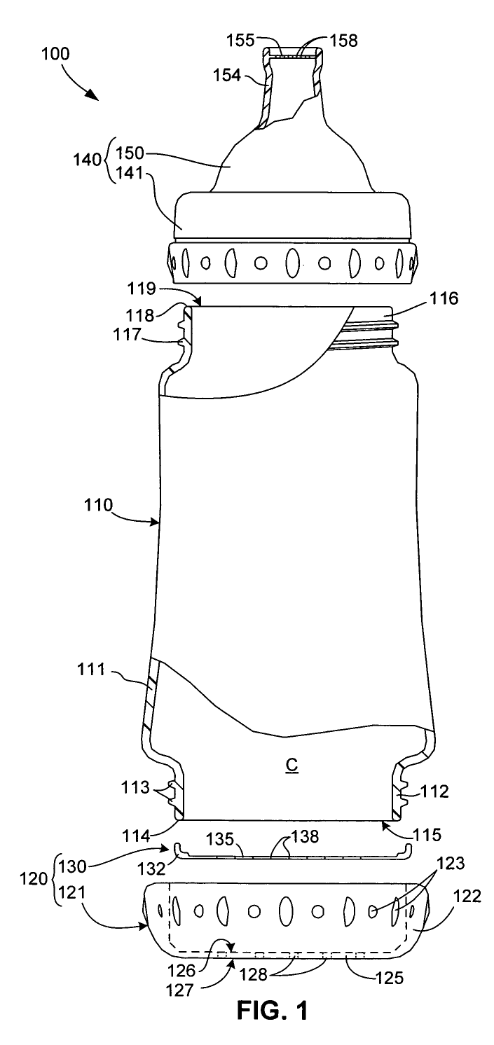

FIG. 1 is a partial cut-away side view showing a baby bottle assembly 100 according to an embodiment of the present invention. Baby bottle assembly 100 generally includes a generally cylindrical bottle (container) body 110, a vent mechanism 120, and a nipple (nozzle) assembly 140.

Bottle body 110 is a plastic structure formed in accordance with known plastic molding techniques. Bottle body 110 includes a roughly cylindrical peripheral wall 111 having a lower (first) end portion 112 that includes external threads 113 and has a lower edge 114 defining a lower (first) opening 115, and an upper (second) end portion 116 that includes external threads 117 and has an upper edge 118 defining an upper (second) opening 119. Peripheral wall 111 surrounds a beverage storage chamber C that is accessible through lower opening 115 and upper opening 119.

Vent mechanism 120 is mounted onto lower portion of bottle body 110 over lower opening 115, and provides the functions described below. Vent mechanism 120 generally includes a support member 121 and a flow control member 130 that are produced separately and assembled onto bottle body as described below.

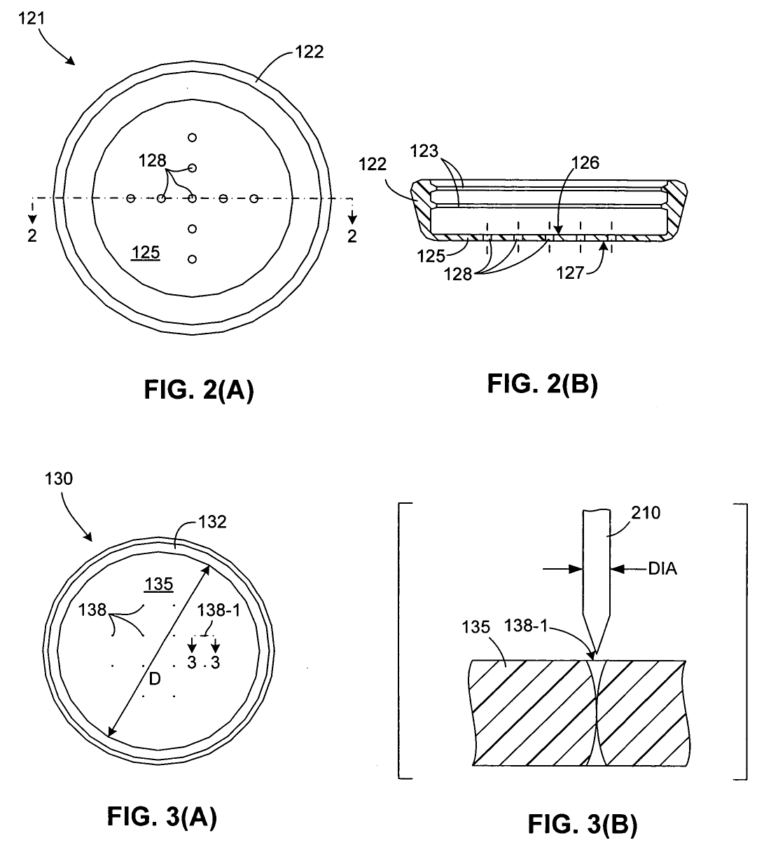

Referring to FIGS. 1, 2(A) and 2(B), support member 121 is a rigid plastic structure formed in accordance with known plastic molding techniques, and includes a collar 122 having inside threads 123 that mate with threads 113 of lower end portion 112, and a rigid support plate 125 that is attached to and supported by collar 122 such that support plate 125 extends over first opening 115. Support plate 125 has an inner surface 126 and an opposing outer surface 127, and defines one or more permanently-open vent holes 128 that extend entirely through support plate 125 between inner surface 126 and outer surface 127.

Referring to FIGS. 1 and 3(A), flow control member 130 includes a relatively thick or otherwise durable peripheral collar 132 and a perforated membrane 135 whose outer edge is suspended in a trampoline-like manner by peripheral collar 132. In accordance with the present invention, membrane 135 includes a sheet of elastomeric material defining a plurality of (e.g., twelve) pinholes 138. In one embodiment, membrane 135 is circular and has a diameter D in the range of 1 and 3 inches, and a thickness in the range of 0.01 to 0.1 inches. As indicated in FIG. 3(B), each pinhole (e.g., pinhole 138-1) is formed by piercing membrane 135 with a pin 210, or other sharp pointed object, such that each pinhole is closed by the surrounding elastomeric material when pin 210 is subsequently removed. In a preferred embodiment, each pin 210 is formed with a continuously curved (e.g., circular) cross section such that each pinhole 138 is substantially circular (i.e., does not have a slit or fold that would be formed by a cutting element having an edge). Note that a pin having a diameter DIA of approximately 0.059 inches was used to produce successful pinholes in a membrane having a diameter of approximately two inches and a thickness of approximately 0.02 inches. In one embodiment, membrane 135 is stretched in a radial direction during the perforation process, thereby facilitating closing of pinholes 138 when the radial tension is subsequently removed.

Referring back to FIG. 1, nipple assembly 140 includes a cap 141 and a nipple 150 that are mounted onto upper end portion (neck) 116 of bottle body 110 in a manner consistent with conventional baby bottles. Cap 141 is a substantially standard structure including a cylindrical base portion having threaded inside surface, and a disk-shaped upper portion that defines a central opening through which a portion of nipple 150 extends. When cap 141 is connected (screwed) onto bottle body 110, the threads formed on the cylindrical base portion mate with threads 117 formed on neck 116. Cap 141 is also molded from a suitable plastic using known methods. Nipple 150 is formed from a suitable elastomeric material (e.g., soft rubber, thermoplastic elastomer, or silicone), and includes a conical wall section 154 extending upward from a base portion (not shown), and a substantially flat, disk-shaped nipple membrane 155 located at the upper portion of upper conical wall section 154. In accordance with an embodiment of the present invention, nipple membrane 155 defines several pinholes 158, which are formed in a manner similar to that described above, to facilitate adjustable liquid flow from storage chamber C through nipple 150. When mounted in bottle assembly 100, a ring-shaped flange portion (not shown) located at a base of nipple 150 is pinched between upper edge 118 of neck 116 and a portion of cap 140.

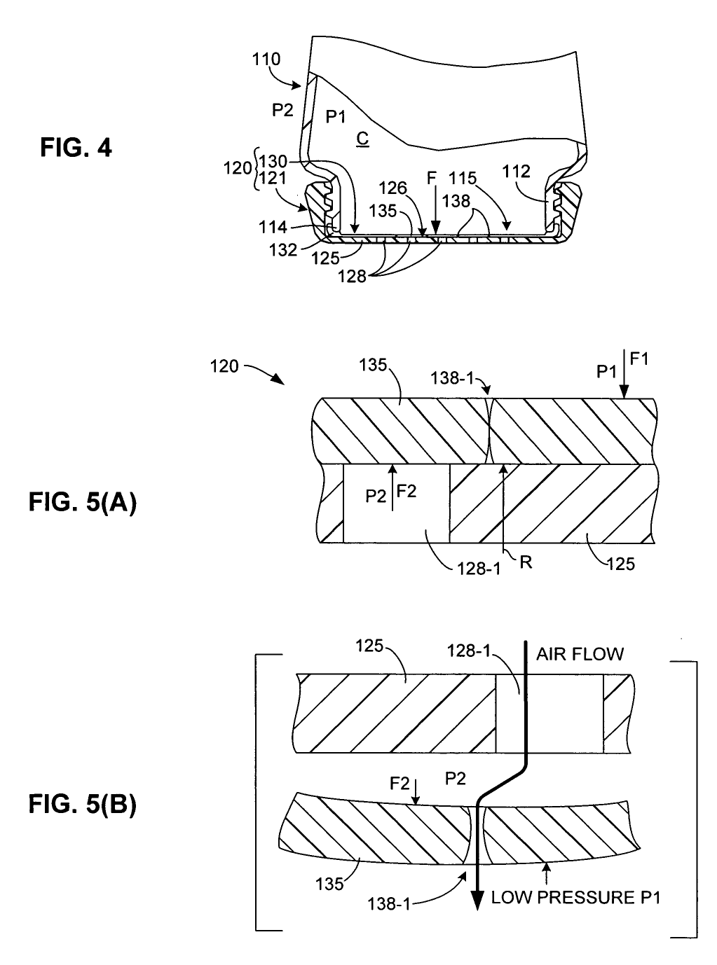

As indicated in FIG. 4, when vent mechanism is mounted on to lower end portion 112 of bottle body 110, peripheral collar 132 is pinched between lower edge 114 and inside surface 126 of support plate 125 (or another structure mounted adjacent to the peripheral edge of support plate 125), thereby supporting membrane 135 such that membrane 135 is positioned between support plate 125 and the storage chamber C. In accordance with an aspect of the invention, membrane 135 is supported such that substantially the entire lower surface of membrane 135 contacts the central portion of support plate 125 when membrane 135 is in an unbiased resting or supported state (i.e., when a pressure P1 inside chamber C is equal to a pressure P outside housing body 110, and/or when membrane 135 is subjected to a sufficient downward force F (e.g., exerted by the weight of a stored liquid) to press membrane 135 against support plate 125).

FIGS. 5(A) and 5(B) respectively illustrate a one-way valve characteristic of vent mechanism 120 that provides pressure equalization (venting) when beverage is drawn out of the baby bottle. As indicated in FIG. 5(A), due to the characteristics of membrane 135, pinhole 138-1 remains closed when membrane 135 is in the resting state, thereby preventing the flow of fluid (liquid or gas) through vent hole 128-1 and membrane 135. That is, while the combination of internal pressure P1 and/or the beverage weight generate a downward force F1 on membrane 135 that is greater than an upward force F2 exerted by external pressure P2, membrane 135 remains substantially planar (i.e., supported by plate 125), and pinhole 138-1 remains closed. In contrast, as shown in FIG. 5(B), when the baby bottle is inverted and beverage is displaced from the baby bottle, e.g., by a feeding baby, the force exerted by the beverage is removed, and the internal pressure P1 is eventually reduced such that the force F2 exerted by the external pressure P2 bends membrane 135 away from support plate 125 (i.e., into the baby bottle). This bending of membrane 135 eventually causes one or more of the pinholes (e.g. pinhole 138-1) to open, thereby admitting air from outside of the bottle into the bottle, thus equalizing pressures P1 and P2. Once pressure is sufficiently equalized, membrane 135 is resiliently biased back into the resting state, thus closing the pinholes and preventing further venting.

Those skilled in the art will recognize that the number of pinholes 138, and the diameter, thickness and flexibility of membrane 135 combine to produce the venting characteristics of the venting mechanism. That is, by forming membrane 125 from a relatively flexible, thin elastomeric sheet, using relatively large pins, or providing a relatively large number of pinholes 138, venting may be caused to occur at a relatively low differential pressure. Conversely, by forming membrane 125 from a relatively stiff, thick elastomic sheet, using relatively small pins, or providing a relatively small number of pinholes 138, venting may be caused to occur at a relatively high differential pressure.

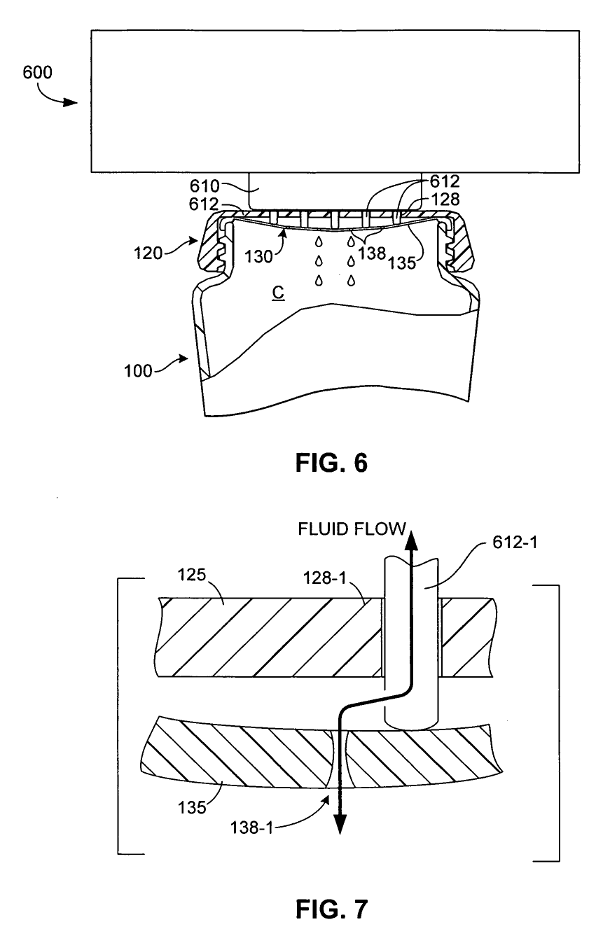

FIGS. 6 and 7 are simplified cross-sectional side views showing a method for flowing a beverage into (or out of) baby bottle 100 through membrane 135 in accordance with another aspect of the present invention. A beverage processing apparatus 600 includes a fixture 610 including several tubes (or rods) 612 that extend through vent holes 128 of support plate 125, and push membrane 135 into a bent state such that pinholes 138 are forced into an open position, and liquid flow is facilitated through tubes 612 into bottle 100. For example, as indicated in FIG. 7, membrane 135 is pushed away from support plate 125 by a rod 612-1, thereby opening pinhole 138-1 to facilitate the flow of beverage and/or air through pinhole 138-1 by way of opening 125-1. In one specific embodiment, apparatus 600 is a breast pump that expresses milk directly into storage chamber C of baby bottle 100 without being exposed to the surrounding air, thus providing a substantially sterile transfer process that avoids contamination. In another embodiment, apparatus 600 may include a convection-type heating device that receives the baby bottle in an upright orientation (e.g., as shown in FIG. 1) such that cool beverage flows through the opened pinholes, is heated, and then returns through the pinholes into the storage chamber, thus producing a convective flow. Once the heating process is completed, the heating unit may be inverted, as indicated in FIG. 6, to cause any remaining beverage to re-enter the bottle.

In addition to the specific embodiment disclosed herein, other features and aspects may be added to the novel baby bottle nipple that fall within the spirit and scope of the present invention. Therefore, the invention is limited only by the following claims.

1. A beverage container assembly comprising:
a container body including a peripheral wall surrounding a storage chamber, the peripheral wall defining an opening; and
a flow control mechanism mounted onto the bottle body over the opening, the flow control member including:
a rigid support plate defining one or more vent holes; and
a perforated membrane mounted between the support plate and the opening, wherein the membrane includes a sheet of elastomeric material defining at least one pinhole, said at least one pinhole being closed by the elastomeric material surrounding said each pinhole when the membrane is in an unbiased resting state, thereby preventing passage of a fluid through the membrane, and said at least one pinhole being opened when the membrane is subjected to an applied force that causes at least a portion of the membrane to bend away from the support plate into the storage chamber, thereby facilitating fluid flow through the membrane.

2. The beverage container assembly according to claim 1,
wherein the support plate includes an inner surface facing the perforated membrane, and
wherein the perforated membrane rests against the support plate when the perforated membrane is in the resting state.

3. The beverage container assembly according to claim 1, wherein the perforated membrane has a circular outer perimeter having a diameter of 1 to 3 inches and a thickness of 0.01 to 0.1 inches, and wherein the membrane comprises a plurality of pinholes.

4. The beverage container assembly according to claim 3, wherein the number of pinholes is greater than five.

5. The beverage container assembly according to claim 1, wherein the perforated membrane comprises one of silicone, a thermoplastic elastomer, and a soft rubber.

6. A beverage container assembly comprising:
a container body including a peripheral wall surrounding a storage chamber, the peripheral wall including a first end portion defining a first opening, and a second end portion defining a second opening; and
a vent mechanism including:
a support member including a collar attached to the first end portion of the peripheral wall, and a rigid support plate attached to the collar and extending over the first opening, the support plate having opposing inner and outer surfaces, and defining one or more vent holes extending between the inner and outer surfaces; and
a flow control member including a relatively thick peripheral collar held between the first end of the peripheral wall and the collar of the support member, and a membrane supported by the peripheral collar such that the membrane is positioned between the support plate and the storage chamber,
wherein the membrane includes a sheet of elastomeric material defining a plurality of pinholes formed such that each pinhole is closed by the elastomeric material surrounding said each pinhole when the membrane is in a resting state, thereby preventing fluid flow through the membrane, and each pinhole is opened when the membrane is subjected to an applied force that causes the membrane to bend away from the support plate, thereby facilitating fluid flow through the membrane.

7. The beverage container assembly according to claim 6, wherein the membrane contacts a central region of the support plate when the membrane is in the resting state.

8. The beverage container assembly according to claim 6, wherein the membrane has a circular outer perimeter having a diameter of 1 to 3 inches and a thickness of 0.01 to 0.1 inches, and wherein the plurality of pinholes comprises a number greater than five.

9. The beverage container assembly according to claim 8, wherein the number of pinholes is greater than ten.

10. The beverage container assembly according to claim 6, wherein the membrane comprises one of silicone, a thermoplastic elastomer, and a soft rubber.

11. The beverage container assembly according to claim 6, further comprising a nozzle assembly mounted on the second end of the container body.

12. The beverage container assembly according to claim 6, wherein the beverage container assembly comprises a baby bottle including a nipple assembly mounted on the second end of the container body.

13. The beverage container assembly according to claim 12, wherein the nipple assembly comprises a nipple including a flat second membrane formed from an elastomeric material and defining a plurality of second pinholes, wherein the second pinholes are formed such that each second pinhole is closed by the elastomeric material surrounding said each pinhole when the second membrane is in a resting state, thereby preventing fluid flow through the second membrane, and each second pinhole is opened when the nipple is subjected to an applied force that causes the membrane to bend, thereby facilitating fluid flow through the membrane.

14. A method for filling a beverage container including a container body defining an opening, and a flow control mechanism mounted onto the bottle body over the opening, the flow control mechanism including a rigid support plate defining one or more vent holes, and a perforated membrane mounted between the support plate and the opening, wherein the membrane includes a sheet of elastomeric material defining a plurality of pinholes, each pinhole being closed by the elastomeric material surrounding said each pinhole when the membrane is in an unbiased resting state, wherein the method comprises:
biasing the pinholes into an open position by inserting a rod through the vent opening and pressing the rod against the membrane until the pinholes are opened;
flowing a liquid through the vent hole onto the membrane such that the liquid passes through the opened pinholes and enters the beverage container; and
removing the rod, thereby causing the membrane to resiliently close the pinholes.
